(19) United States
(12) Patent Application Publication
(10) Pub. No.: US 2026/0015115 A1
(43) Pub. Date: Jan. 15, 2026

(54) PACKAGING-MACHINE DEVICE, AND METHOD HAVING SUCH A PACKAGING-MACHINE DEVICE

(71) Applicant: Syntegon Packaging Systems AG, Beringen (CH)

(72) Inventors: Raphael Krieger, Diessenhofen (CH); Michael Lopes, Stockach (DE); Maurizio Maj, Winterthur (CH)

(21) Appl. No.: 18/881,882

(22) PCT Filed: Jul. 7, 2023
(86) PCT No.: PCT/EP2023/068828

§ 371 Date: Jan. 7, 2025

(30) Foreign Application Priority Data
Jul. 7, 2022 (DE) 10 2022 117 004.7

(51) Int. Cl. B65B 9/12; B65B 9/20

(52) U.S. Cl. CPC B65B 9/12; B65B 9/2007

(57) ABSTRACT

A packaging machine device includes at least one closure device (10), in particular a sealing device, for producing at least one closure seam (12, 14), in particular a sealing seam, on at least one packaging material (16), and includes a forming device (18) configured to form the packaging material (16), which has been pre-formed into a tubular bag, in a region of the closure seam (12, 14), in particular at least partly before a production of the closure seam (12, 14). The forming device (18) is configured to form the packaging material (16) in the region of the closure seam (12, 14), starting from an inner region (24) of the closure seam (12, 14) in a direction (30, 32) towards at least one outer region (26, 28) of the closure seam (12, 14).

### CROSS-REFERENCE TO RELATED APPLICATIONS

This patent application is a U.S. national stage application of international patent application PCT/EP2023/068828, filed on Jul. 7, 2023, which is based on and claims priority to German patent application DE 10 2022 117 004.7, filed on Jul. 7, 2022, the contents of which are incorporated herein by reference.

### BACKGROUND

The invention in particular concerns a packaging machine device with at least one closure device, in particular a sealing device, for producing at least one closure seam, in particular a sealing seam, on at least one packaging material.

Such packaging machine devices are already known. In packaging machines with such packaging machine devices, the packaging material is formed into a tubular bag. During a packaging process of products and during a closing of the tubular bag into individual packagings, tensions are induced in the tubular bag, which may result in incorrect folds/corner folds.

From DE 37 32 033 A1, AU 1985/43753 B2, JP 2003-11 923 A, DE 38 37 709 A1 and U.S. Pat. No. 6,138,442 A, for example, packaging machines with a packaging machine device are already known, wherein the packaging machine device comprises at least one closure device, in particular a sealing device, for producing at least one closure seam, in particular a sealing seam, on at least one packaging material, and comprises a forming device which is configured to form, in particular to compress, the packaging material, which has been pre-formed into a tubular bag, in a region of the closure seam, in particular at least partly before a production of the closure seam, in order to sweep filling material away from the region of the closure seam that is to be introduced.

### SUMMARY

The objective of the invention is in particular to provide a generic packaging machine device with improved characteristics regarding process reliability and in particular tightness of produced packagings. The objective is achieved according to the invention.

The invention is based on a packaging machine device with at least one closure device, in particular a sealing device, for producing at least one closure seam, in particular a sealing seam, on at least one packaging material, and with a forming device configured to form the packaging material, which has been pre-formed into a tubular bag, in a region of the closure seam, in particular at least partly before a production of the closure seam.

It is proposed that the forming device is configured to form the packaging material in the region of the closure seam, starting from an inner region of the closure seam in a direction towards at least one outer region of the closure seam.

In this context, various devices, which are deemed suitable by someone skilled in the art and by means of which a tubular bag can be sealed expediently, such as folding and/or gluing devices, especially advantageously sealing devices, are conceivable as a “closure device”.

“Sealing” is to mean any sealing methods deemed expedient by someone skilled in the art, such as in particular cold sealing, hot sealing, ultrasonic sealing, separation-sealing, etc.

It is also conceivable that not only one packaging material is provided, but several packaging materials are provided, such as for example a carrier material and a barrier material, which are brought together.

Various seams deemed suitable by someone skilled in the art, such as for example a longitudinal seam running in the longitudinal direction of the tubular bag, especially advantageously a transverse seam running transversely to the longitudinal direction of the tubular bag and in particular also parallel to a separation line at which the tubular bag is separated off and/or perforated for a separation of individual packagings, are conceivable as a “closure seam”.

In this context, a “forming device” is to mean devices which are configured for a folding, in particular pre-folding, and/or especially preferentially for a smoothing of the packaging material, namely when the packaging material has been formed into a tubular bag by forming members such as forming shoulders and/or one or more folding boxes, by means of which the packaging material is formed into a tubular bag in particular by point loads and/or line loads. Furthermore, a “forming device” is to mean a device having forming surfaces which are realized separately from closing surfaces of the closure device and are configured for the production of the closure seam, such as in particular sealing surfaces of a sealing jaw. The forming device in particular comprises a forming unit which is realized separately from a forming unit by which the packaging material is formed into the tubular bag. Preferably the forming device comprises a forming unit which is arranged spatially separate from a forming unit configured for the forming of the tubular bag. The forming device preferably comprises a forming unit which is configured to contact the tubular bag before closure members of the closure device, such as in particular sealing jaws, contact the tubular bag. In particular, the forming process is at least largely completed when tubular bag walls of the tubular bag are contacted by closure members, such as in particular by sealing jaws, and are subjected to pressure and/or temperature.

The forming device preferably comprises a forming unit which, viewed in a movement direction of the tubular bag and at a contact time thereof, is arranged downstream of closure members, such as in particular sealing jaws, of the closure device, wherein the forming device may also comprise a forming unit which, viewed in a movement direction of the tubular bag and at a contact time thereof, is arranged upstream of closure members, such as in particular sealing jaws, of the closure device.

In this context, “in a region of the closure seam” is to mean that at least one region of the packaging material is formed by the forming device, said region having a distance from the closure seam which is smaller than half a length of a packaging that is to be produced, preferably smaller than a quarter of the length of the packaging to be produced, and/or smaller than 8 cm, preferably smaller than 4 cm, wherein a “length of the packaging” is to mean a dimension of the packaging to be produced in the longitudinal direction of the packaging tube.

“Configured” is in particular to mean specially furnished, specially designed and/or specially equipped. By an object being configured for a specific function is in particular to be understood that the object fulfils and/or carries out this specific function in at least one application state and/or operation state.

By means of the implementation according to the invention, incorrect folds/corner folds induced by tensions in the tubular bag in the region of the closure seam may at least be reduced. It is possible to produce, with a particularly high process reliability, particularly tight packagings as well as visually attractive closure seams, especially advantageously if the forming device is configured to form the packaging material, which has been pre-formed into a tubular bag, in the region of the closure seam at least partly before a production of the closure seam. Alternatively or preferably additionally, the forming device may also be configured to form the packaging material, which has been pre-formed into a tubular bag, in the region of the closure seam at least partly after a production of the closure seam.

Advantageously, as already explained, the closure seam is formed by a transverse seam and the forming process by means of the forming device takes place chronologically after a production of a longitudinal seam of the tubular bag.

Particularly advantageously it is also possible to produce, with particularly high process reliability, packagings with packaging materials which, in comparison to standard packaging materials, place principally higher requirements with regard to processability. Especially advantageously, it is herein possible to process packaging materials having a thickness greater than 30 μm, preferably greater than 40 μm and very particularly preferably greater than 60 μm, packaging materials produced at least by 20%, preferably at least by 40% and particularly preferably at least by 60% from recycled material, packaging materials produced at least by 20%, preferably at least by 40% and particularly preferably at least by 60% from renewable raw material, as well as packaging materials produced at least by 10% and preferably at least by 20% from aluminum and/or an aluminum composite material.

“Renewable raw materials” are here to mean organic raw materials, in particular vegetable raw materials, which originate from agricultural and/or forestry production and are in particular cultivated by humans in a targeted manner for further application purposes outside the food and feed industry or which are by-products and/or waste products from agriculture and/or from the food and feed industry. Renewable raw materials in the meaning of the present application are exclusively organic raw materials that are not of fossil origin. Preferably, in the present case renewable raw materials are local products from agricultural and/or forestry production and their by-products and/or residual materials, insofar as these are not subject to the waste law, as well as algae.

Especially advantageously, it is also possible to process packaging materials that have been produced at least partly from a fibrous material and/or from a paper material.

The forming by means of the forming device, in particular the smoothing of the packaging material, may be brought about in various ways deemed expedient by someone skilled in the art, such as for example by a simple flattening by pressure. Especially advantageously, however, the forming device is configured to contact the packaging material, viewed in a projection plane that extends parallel to the closure seam and parallel to the longitudinal direction of the tubular bag and/or to a movement direction of the tubular bag, in a target-oriented manner consecutively in different regions and thereby to form, in particular to smooth, the packaging material. This allows achieving especially advantageous formings, in particular smoothings, and it is also possible to remove air from the tubular bag in a target-oriented manner. Especially advantageously, the forming device may also be configured to generate a relative movement, i.e. a kind of sweeping movement, between a forming surface of a forming unit of the forming device, which is in contact with the packaging material, and the packaging material, in particular viewed in the projection plane that extends parallel to the closure seam and parallel to the longitudinal direction of the tubular bag and/or to a movement direction of the tubular bag. Such a sweeping movement is achievable by a movement of the forming surface relative to the packaging material and/or is achievable by a movement of the packaging material relative to the forming surface.

Especially advantageously, the forming device is configured to form the packaging material in the region of the closure seam, starting from an inner region of the closure seam towards two outer regions of the closure seam, as a result of which it is especially advantageously in particular possible to at least reduce, respectively remove, undesired corner folds. Such a contacting is attainable in various ways deemed expedient by someone skilled in the art, for example by directed movements of one or several forming surfaces of at least one forming unit of the forming device relative to the packaging material, wherein for example the forming unit is guided on a special cam track, driven by one or several actuators, and/or such that the forming device comprises a forming unit which, viewed at a time of contact with the packaging material, has a geometry that changes spatially in a progression in a direction of the closure seam, as a result of which it is achievable a constructionally simple manner that the forming unit forms the packaging material in the region of the closure seam, starting from an inner region of the closure seam in a direction towards at least one outer region of the closure seam. In this context, a “changed geometry of a component” is to mean that, viewed at a point in time and viewed in the progression of a specific direction, at least one dimension of the component changes.

Preferably a forming unit of the forming device has such a shape that, viewed in a projection plane perpendicular to a movement direction of the forming unit during operation, starting from a middle region of the closure seam along the closure seam towards one, preferably towards both end regions of the closure seam, a distance between the forming unit and the closure seam, respectively a closure contact point of the closure unit, increases, which is preferably achievable by an inclined surface and/or by a curvature. Herein the distance changes by at least 0.2 mm, preferably by at least 0.5 mm and most preferably by at least 1 mm. Alternatively and/or additionally, the forming unit could be realized with different thicknesses, for example preferably dome-like. The forming unit is preferably configured to generate a diverging arrangement of pressure lines.

Furthermore, it is proposed that the forming device is configured to form the packaging material in the region of the closure seam transversely to the closure seam, particularly preferably in that the forming device comprises a forming unit which, viewed at a time of contact with the packaging material, has a geometry which changes spatially in a progression transversely to the closure seam. Especially preferentially, the forming device is configured to pre-form the packaging material in the region of the closure seam, transversely to the closure seam, towards the closure seam, as a result of which, in addition to advantageous forming, in particular smoothing, it is advantageously possible to guide air out of the tubular bag. In the case of a forming device comprising a forming unit which, viewed in a movement direction of the tubular bag and at a contact time thereof, is arranged upstream of closure members, such as in particular sealing jaws, of the closure device, the forming device is preferably configured to form the packaging material transversely to the closure seam and away from the closure seam.

In a further implementation of the invention, it is proposed that the forming device comprises a bearing unit by means of which a forming unit of the forming device is supported pivotably, as a result of which advantageous forming movements are enabled in a constructionally simple manner. However, alternatively or in addition to a pivotable support, the forming unit may be supported in a translationally movable manner.

If the forming device comprises a bearing unit which is realized at least partly integrally with a bearing unit of the closure device, additional components and costs can be saved. In this case, a forming unit of the forming device is preferably supported so as to be movable together with a closure unit, such as in particular a sealing jaw.

It is further proposed that the forming device comprises a forming unit which is realized so as to be deformable, in particular elastically deformable, wherein in this context “deformable” is to mean that the forming unit is realized in such a way that it undergoes a dimensional change of at least 0.5 mm during the deformation of the packaging material. Preferably, the forming unit is herein elastically deformed, preferably compressed. Advantageously the forming unit is formed at least partly from an elastomer and/or from a foam material. The forming unit further comprises a base body made of a first material, such as preferably of steel, and comprises a layered body arranged thereon, in particular applied thereto, that is made of a second material, such as preferably of a material having a lower hardness than a material of the base body.

Moreover, a production method for producing a forming unit of a forming device of a packaging machine device according to the invention is proposed, which is characterized by at least one additive process step, preferably a 3D printing process step, as a result of which the forming unit can be implemented in a particularly flexible and cost-effective manner and thus particularly advantageous forming of the packaging material is achievable. Alternatively or in addition to a 3D printing method, further additive process steps, deemed expedient by someone skilled in the art, are also conceivable, such as in particular injection-molding method steps in which a material is applied in one or several layers to an already existing object.

The devices, machines, units and methods according to the invention shall here not be limited to the applications and implementations described above. Moreover, as for the value ranges given in this disclosure, values lying within the mentioned limits shall also be considered as disclosed and usable as desired.

### BRIEF DESCRIPTION OF THE DRAWINGS

Further advantages will become apparent from the following description of the drawings. An exemplary embodiment of the invention is illustrated in the drawings. The drawings, the description and the claims contain a plurality of features in combination. Someone skilled in the art will purposefully also consider the features individually and will find further expedient combinations.

In the drawings:

FIG. 1 shows a detail of a schematically illustrated packaging machine with a packaging machine device according to the invention,

FIG. 2 shows an enlarged detail II from FIG. 1 at a first point in time,

FIG. 3 shows the enlarged detail II at a second point in time,

FIG. 4 shows a view of a forming unit of a forming device in a projection plane perpendicular to a movement direction of the forming unit during operation,

FIG. 5 shows a sectional representation along the line V-V in FIG. 4,

FIG. 6 shows a packaging produced with the packaging machine illustrated in FIG. 1, and

FIG. 7 shows a forming unit of the forming device according to the invention during a production thereof in an additive process.

### DETAILED DESCRIPTION

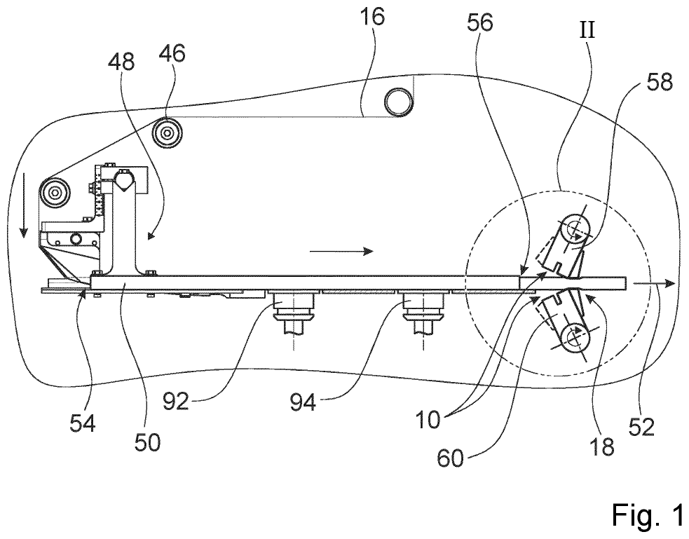

FIG. 1 shows a detail of a schematically illustrated packaging machine with a packaging machine device according to the invention. The packaging machine is preferably realized as a horizontal machine, as illustrated, but could also be realized as a vertical machine.

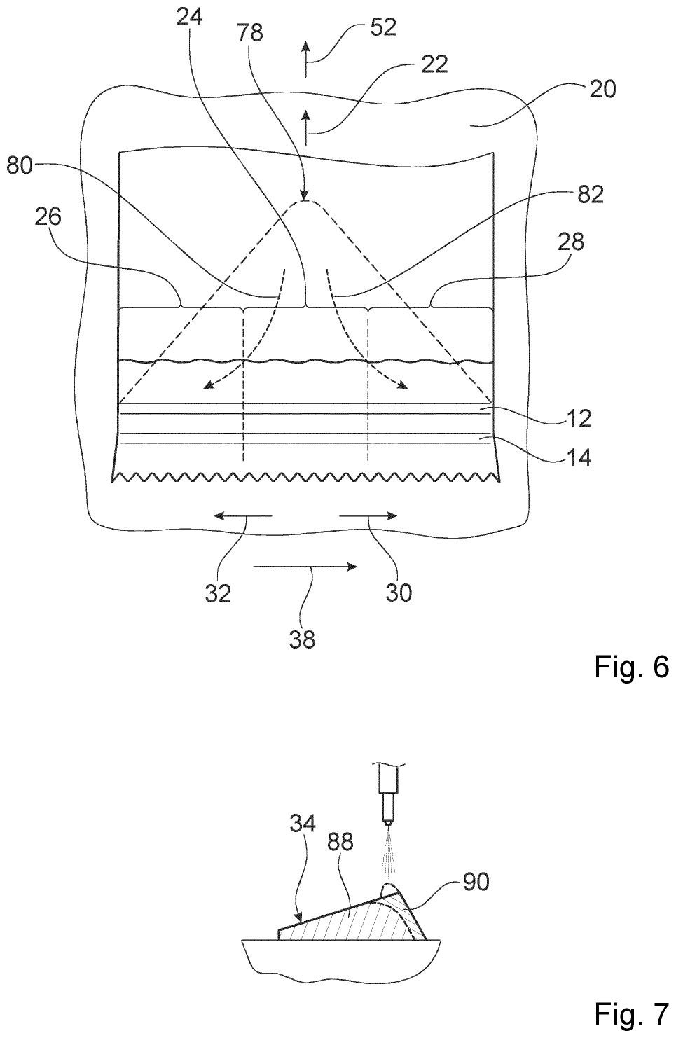

The packaging machine device comprises a closure device 10, specifically a sealing device, for the production of two closure seams 12, 14 realized as sealing seams on a packaging material 16. The closure seams 12, 14 are transverse seams. FIG. 6 shows a packaging produced by means of the packaging machine with the closure seams 12, 14 that are realized as transverse seams.

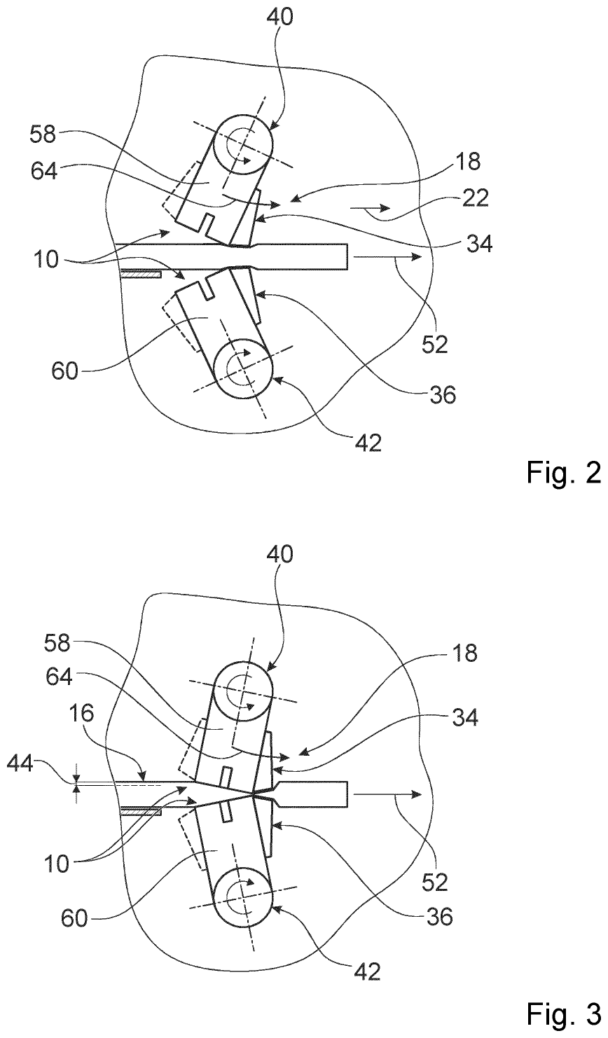

The packaging machine device comprises a forming device 18, which is configured to pre-form, specifically to smooth and partially evacuate, the packaging material 16, which has been pre-formed into a tubular bag, in a region of the closure seams 12, 14 before a production of the closure seams 12, 14 (cf. FIGS. 1 to 5).

The packaging material 16 is unrolled from a roll (not illustrated in detail) and is fed via deflection pulleys 46 to a forming unit 48, in which the packaging material 16, which up to this point in time has been planar, is formed into the tubular bag (cf. FIG. 1). The tubular bag is fed to a guide tunnel 50. At an end 54 of the guide tunnel 50 that points counter to a movement direction 52 of the tubular bag, product to be packaged is conveyed into the tubular bag by means of a conveying apparatus (not illustrated in detail). At an end 56 that points in the movement direction 52 of the tubular bag, the tubular bag is fed to the packaging machine device with the forming device 18 and the closure device 10.

Between the ends 54, 56 of the guide tunnel 50, a longitudinal sealing seam is produced on the tubular bag by means of sealing rollers 92, 94.

The forming device 18 comprises two forming units 34, 36, which form preform surfaces that come into contact with the packaging material during a preforming process before sealing jaws 58, 60 of the closure device 10 come into contact with the packaging material 16, and in particular before walls of the tubular bag are brought together by means of the sealing jaws 58, 60 and are then subjected to pressure.

The forming device 18 is configured to contact the packaging material 16-viewed in a projection plane 20 (cf. FIGS. 1 and 6) extending parallel to the closure seam 12, 14 and parallel to a longitudinal direction 22 of the tubular bag and to the movement direction 52 of the tubular bag-in a target-oriented manner consecutively in different regions 24, 26, 28 and in this way to form, in particular to smooth, the packaging material 16. By means of the forming device 18 it is achieved that the packaging material 16, respectively the packaging tube, is oriented at least primarily with respect to the forming units 34, 36 and not to the product to be packaged, which may have an uneven contour.

The forming device 18 is configured, independently of a contour of the product that is to be packaged, to pre-form the packaging material 16 in the region of the closure seams 12, 14, starting from an inner region 24 of the closure seams 12, 14 in opposed directions 30, 32 towards outer regions 26, 28 of the closure seams 12, 14.

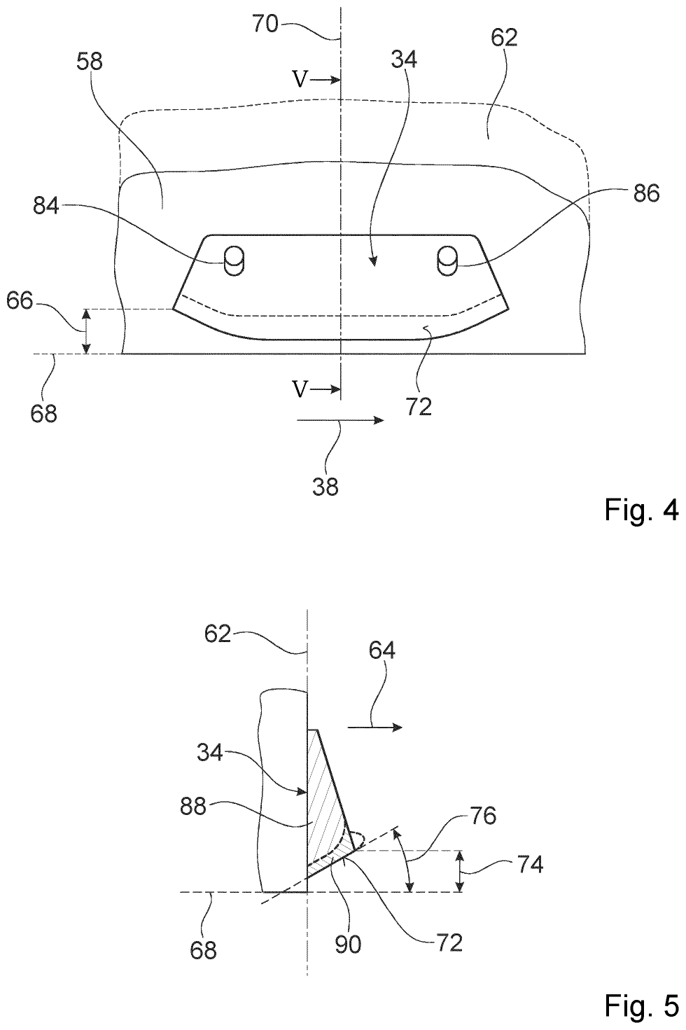

For this purpose, the forming units 34, 36 of the forming device 18, viewed at a time of contact with the packaging material 16, have a geometry which changes spatially in a progression in the direction 38 of the closure seams 12, 14, which will be described below with reference to the forming unit 34, wherein this applies accordingly to the forming unit 36 (cf. FIG. 4). Viewed in a projection plane 62 perpendicular to a movement direction 64 of the forming unit 34 during operation, starting from a middle region of the closure seams 12, 14 viewed along the closure seams 12, 14 towards both end regions of the closure seams 12, 14, the packaging machine device has an increasing distance 66 between the forming unit 34 and a contact plane 68 of the closure device 10, said contact plane 68 extending perpendicular to the projection plane 62 and sealing jaw contact surfaces being situated in the contact plane 68. Herein the distance 66 changes by more than 1 mm in the exemplary embodiment shown. Viewed in a progression in the direction 38, the forming unit 34 has a constant thickness. However, the forming unit 34 could preferably, in particular in the middle region, have a greater thickness than in the side regions and could thus be realized in dome-like fashion.

The forming device 18 is furthermore configured to pre-form the packaging material 16 in the region of the closure seams 12, 14 transversely to the closure seams 12, 14, specifically preferably without contacting—and thus possibly damaging—the product to be packaged. Viewed at a time of contact with the packaging material 16, the forming units 34, 36 have a geometry which changes spatially in a progression transversely to the closure seams 12, 14.

Viewed in a sectional plane 70 perpendicular to the projection plane 62, the forming unit 34 has an outer surface 72 facing towards the packaging material 16 and having, viewed in the progression of the movement direction 64 of the forming unit 34, an increasing distance 74 from the contact plane 68 of the closure device 10. Herein the distance 74 changes by more than 1 mm in the exemplary embodiment shown.

The outer surface 72 is realized as a surface extending at an inclination with respect to the contact plane 68, but could also be realized in curved fashion. An angle 76 between the outer surface 72 and the contact plane 68 is preferably between 0° and 90°, particularly preferably between 20° and 70°. The angle 76 is herein preferably selected as a function of a desired folding triangle 78 and of a pull-off length of the packaging material 16 (cf. FIG. 6).

In FIG. 6, pre-forming lines 80, 82, respectively printing lines, are shown along which the packaging material 16 is pre-formed by means of the forming units 34, 36 independently of a contour of the product to be packaged, and along which pressure is applied onto the packaging material 16 by the forming unit 34. The pre-forming lines 80, 82 are realized so as to diverge, counter to the movement direction 52 of the tubular bag, towards the closure seams 12, 14. The pre-forming lines 80, 82 are furthermore realized in curved fashion.

The forming device 18 comprises bearing units 40, 42 by means of which the forming units 34, 36 of the forming device 18 are supported pivotably (cf. FIGS. 1 to 3). The bearing units 40, 42 are realized integrally with bearing units of the closure device 10, and specifically the bearing units 40, 42 are realized as transverse sealing shafts. The sealing jaws 58, 60 are arranged on the transverse sealing shafts and are supported so as to be pivotable via the transverse sealing shafts. The forming units 34, 36 are in each case arranged on the sealing jaws 58, 60 on a side that points in the pivoting direction, specifically the forming units 34, 36 are fastened directly on the sealing jaws 58, 60. Due to the forming units 34, 36 being elastically deformable, they can project, starting from pivot axes of the bearing units 40, 42, beyond the sealing jaws 58, 60 in a radial direction. Alternatively, the forming units 34, 36 could also be fastened directly on the transverse sealing shafts or on support rings (not illustrated in detail) which are fastened on the transverse sealing shafts.

The forming unit 34 is supported on the sealing jaw 58 in such a way that it is adjustable in its position (cf. FIG. 4). For this purpose, the forming unit 34 has long holes 84, 86. The same applies accordingly to the forming unit 36.

Viewed at a sealing time, the forming units 34, 36 are arranged on a side of the sealing jaws 58, 60 that points in the movement direction 52 of the tubular bag (cf. FIGS. 1 to 3). In addition, on a side pointing counter to the movement direction 52 of the tubular bag, forming units could be arranged on the sealing jaws 58, 60, as indicated schematically, for the purpose of advantageously forming and preferably at least partly evacuating the packaging material 16, preferably viewed in the movement direction 52 of the tubular bag spatially upstream and/or downstream of the closure seams 12, 14 and chronologically before and/or after the production of the closure seams 12, 14. Herein the forming units 34, 36 may be realized so as to be structurally identical to the forming units on the opposite side of the sealing jaws 58, 60, in particular in the case of translationally displaceable sealing jaws, or also so as to be differing, in particular in the case of pivotably supported sealing jaws 58, 60 according to the exemplary embodiment shown.

The forming units 34, 36 are realized so as to be elastically deformable and are elastically deformed during the forming of the packaging material 16. The forming units 34, 36 are produced in a production method with an additive process step, specifically in a 3D printing process step, as illustrated in FIG. 7 with reference to the forming unit 34, wherein the same applies accordingly to the forming unit 36. The forming unit 34 comprises a base body 88 made of steel, onto which an elastomer layer 90 is printed in the additive process step. The elastomer layer 90 could also be realized so as to project beyond an upper side of the base body 88, as indicated by dashed lines in FIGS. 5 and 7, in particular in order to achieve a larger outer surface 72 and an improved deformability of the elastomer layer 90.

Alternatively, the entire forming unit 34 could also be produced in a 3D printing procedure or in a multi-component injection-molding procedure. The elastomer layer 90 is compressed during the forming process, specifically preferably by more than 0.5 mm.

The processed packaging material 16 has a thickness 44 of 65 μm (cf. FIG. 3). The packaging material 16 is an aluminum composite material that consists at least by 20% of aluminum, at least by 40% of recycled material and at least by 40% of renewable raw material, in particular of a paper material. In principle, however, various compositions, deemed expedient by someone skilled in the art, are conceivable.

1. A packaging machine device comprising:
at least one closure device (10) for producing at least one closure seam (12, 14) on at least one packaging material (16), and a forming device (18) configured to form the packaging material (16), which has been pre-formed into a tubular bag, in a region of the closure seam (12, 14),
wherein the forming device (18) is configured to form the packaging material (16) in the region of the closure seam (12, 14), starting from an inner region (24) of the closure seam (12, 14) in a direction (30, 32) towards at least one outer region (26, 28) of the closure seam (12, 14).

2. The packaging machine device according to claim 1, wherein the forming device (18) is configured to contact the packaging material (16), viewed in a projection plane (20) that extends parallel to the closure seam (12, 14) and parallel to a longitudinal direction (22) of the tubular bag and/or to a movement direction (52) of the tubular bag, in a target-oriented manner consecutively in different regions (24, 26, 28) and in this way to form the packaging material (16).

3. The packaging machine device according to claim 1, wherein the forming device (18) comprises a forming unit (34, 36) which, viewed at a time of contact with the packaging material (16), has a geometry which changes spatially in a progression in a direction (38) of the closure seam (12, 14).

4. The packaging machine device according to claim 1, wherein the forming device (18) is configured to form the packaging material (16) in the region of the closure seam (12, 14) transversely to the closure seam (12, 14).

5. The packaging machine device according to claim 4, wherein the forming device (18) comprises a forming unit (34, 36) which, viewed at a time of contact with the packaging material (16), has a geometry which changes spatially in a progression transversely to the closure seam (12, 14).

6. The packaging machine device according to claim 1, wherein the forming device (18) comprises a bearing unit (40, 42) by which a forming unit (34, 36) of the forming device (18) is supported pivotably.

7. The packaging machine device according to claim 1, wherein the forming device (18) comprises a bearing unit (40, 42) which is configured at least partly integrally with a bearing unit of the closure device (10).

8. The packaging machine device according to claim 1, wherein the forming device (18) comprises a forming unit (34, 36) which is configured so as to be deformable.

9. A forming device (18) for a packaging machine device according to claim 1.

10. A forming unit (34, 36) for a forming device (18) according to claim 9.

11. A packaging machine with a packaging machine device according to claim 1.

12. A method with a packaging machine device according to claim 1, wherein the forming device (18) is used to form the packaging material (16), which has been pre-formed into a tubular bag, in a region of the closure seam (12, 14), wherein the forming device (18) is used to form the packaging material (16) in the region of the closure seam (12, 14), starting from an inner region (24) of the closure seam (12, 14) in a direction (30, 32) towards at least one outer region (26, 28) of the closure seam (12, 14).

13. The method according to claim 12, wherein the forming device (18) is used to contact the packaging material (16), viewed in a projection plane (20) extending parallel to the closure seam (12, 14) and parallel to a longitudinal direction (22) of the tubular bag and/or to a movement direction (52) of the tubular bag, in a target-oriented manner consecutively in different regions (24, 26, 28) and in this way to form the packaging material (16).

14. The method according to claim 12, wherein the forming device (18) is used to form the packaging material (16) in the region of the closure seam (12, 14) transversely to the closure seam (12, 14).

15. The method according to claim 12, wherein a forming unit (34, 36) of the forming device (18) is deformed during the forming of the packaging material (16).

16. The method according to claim 12, wherein a packaging material (16) having a thickness (44) greater than 30 μm is processed.

17. The method according to claim 12, wherein a packaging material (16) is processed that has been produced at least by 20% from recycled material.

18. The method according to claim 12, characterized in that wherein a packaging material (16) is processed that has been produced at least by 20% from renewable raw material.

19. The method according to claim 12, characterized in that wherein a packaging material (16) is processed that has been produced at least by 10% from aluminum.

20. A production method for producing a forming unit (34, 36) of a forming device (18) of a packaging machine device according to claim 1, comprising at least one additive process step.
